(19) United States
(12) Patent Application Publication
(10) Pub. No.: US 2010/0217873 A1
(43) Pub. Date: Aug. 26, 2010

(54) METHOD AND SYSTEM FOR SIP ACCESS TO MEDIA AND CONFERENCES

(75) Inventor: Vladimir Smelyansky, Glenview, IL (US)

Correspondence Address: Hanify & King Professional Corporation, 1055 Thomas Jefferson Street, NW, Suite 400, WASHINGTON, DC, 20007, US

(73) Assignee: XCAST LABS, INC., Northfield, IL (US)

(21) Appl. No.: 12/710,061

(22) Filed: Feb. 22, 2010

Related U.S. Application Data
(60) Provisional application No. 61/154,492, filed on Feb. 23, 2009.

(51) Int. Cl. G06F 15/16

(52) U.S. Cl. 709/227

(57) ABSTRACT

A method and system for SIP access to media and conferences using a Media Server provides multiple connections to a resource while at the same time releasing the connection from the Media Server, therefore minimizing resources required on the Media Server and providing an increased number of connections. A method for providing media services may comprise receiving a request for media services from an initiating client device at a Media Server, determining, at the Media Server, a type of media resource needed to service the request and selecting a Resource Server based on the determined type of media resource, and establishing, by the Media Server, a media service connection between at least the initiating client device and the selected Resource Server to provide the requested media service, wherein the established media service connection does not include the Media Server.

### CROSS-REFERENCE TO RELATED APPLICATIONS

This application claims the benefit of Provisional Application No. 61/154,492, filed Feb. 23, 2009, the contents of which are incorporated herein in their entirety.

### BACKGROUND OF THE INVENTION

1. Field of the Invention

The present invention relates to a method and system for providing a SIP subscriber with to access films, faxes, images and conferences using a media server.

2. Description of the Related Art

The advent of new telecommunication standards, such as Session Initiation Protocol (SIP), Resource Reservation Protocol (RSVP), and Open Settlement Protocol (OSP), have allowed the possibility of new services above and beyond voice, such as access to media. In a conventional system, media connections are established and service is provided using a proxy server function known as a “Media Server”, which allows subscribers to access conferences, faxes and movies from a SIP-based telephone or soft phone. However, Media Servers have limited resources, which limits the number of connections that can be handled by any one Media Server. A need arises for a system that provides more connections and greater expandability than conventional systems.

### SUMMARY OF THE INVENTION

A method and system for SIP access to media and conferences using a media server provides multiple connections to a resource while at the same time releasing the connection from a server, such as a Media Sever, therefore minimizing resources required on this server and providing an increased number of connections. The functionality may be implemented as a subset or feature of a proxy server, or the functionality may be implemented as a self-contained package.

For example, a method for providing media services may comprise receiving a request for media services from an initiating client device at a Media Server, determining, at the Media Server, a type of media resource needed to service the request and selecting a Resource Server based on the determined type of media resource, and establishing, by the Media Server, a media service connection between at least the initiating client device and the selected Resource Server to provide the requested media service, wherein the established media service connection does not include the Media Server. The type of the requested media service may comprise at least one of an audio service, a video service, an audio/video service, an image service, a fax service, and a conference service. The selected Resource Server may comprise at least one of an audio server, a video server, an audio/video server, an image server, a fax server, and a conference server. The Media Server may be implemented as a subset or feature of a proxy server, or the Media Server is implemented as a self-contained package.

As another example, a method for providing conference services may comprise accepting connection, at a Media Server, from a calling client device, establishing, at the Media Server, an inbound leg of a media stream with the calling client device, connecting, from the Media Server, to at least one called client device, establishing, at the Media Server, an outbound leg of the media stream with the at least one called client device, determining, at the Media Server, that at least one called client device has accepted connection to the media stream, completing, at the Media Server, a connection between the calling client device and the at least one called client device, the connection including the inbound leg of the media stream and the outbound leg of the media stream, and waiting, at the Media Server, a predetermined amount of time, then releasing the media stream by establishing a media stream between the calling client device and the at least one called client device that does not include the Media Server. The Media Server may be implemented as a subset or feature of a proxy server, or the Media Server is implemented as a self-contained package. Before establishing the inbound leg of a media stream, the Media Server may authenticate the calling client device.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary diagram of block diagram of a network system in which the present invention may be implemented.

FIG. 2 is an exemplary flow diagram of a process of media connection of two or more client devices

FIG. 3 is an exemplary data flow diagram of media connection of two or more client devices.

FIG. 4 is an exemplary flow diagram of a process of media connection of a variety of types of media streams, using a number of different types of Resource Servers.

FIG. 5 is an exemplary data flow diagram of media connection of one or more client devices with media stream using one or more Resource Servers.

FIG. 6 is an exemplary flow diagram of a process of conference connection of two or more client devices.

FIG. 7 is an exemplary block diagram of a computer system, such as a Media Server or a Resource Server.

### DETAILED DESCRIPTION OF THE INVENTION

A method and system for SIP access to media and conferences using a media server provides multiple connections to a resource while at the same time releasing the connection from a server, such as a Media Sever, therefore minimizing resources required on this server and providing an increased number of connections.

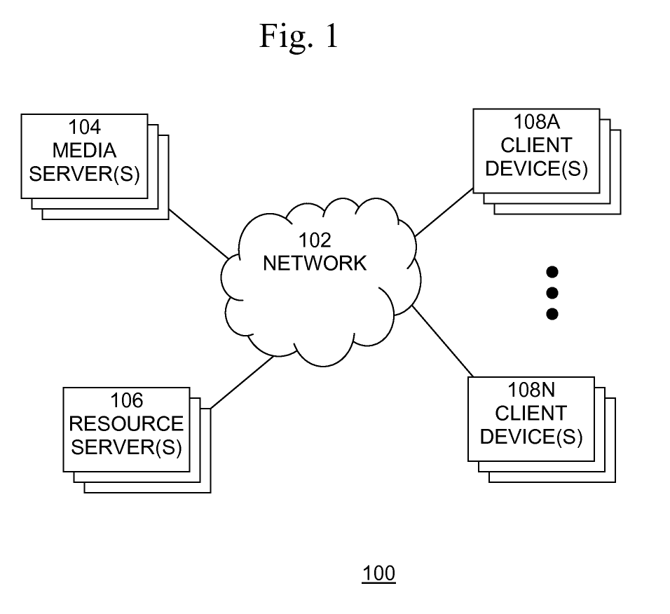

As an example, such features may be provided in a network system 100 such as that shown in FIG. 1. FIG. 1 shows a network 102, one or more Media Servers 104, one or more Resource Servers 106, and a plurality of client devices 108A-N. Network 102 includes any communications network that is now in service or which may be developed in the future. Such a network may include one or more public or private communications networks, such as the Internet, wired or wireless telephone networks, wired or wireless data networks, local area networks, etc. Media Servers 104 are servers that provide access to media of various kinds, such as audio, video, images, faxes, conferences, etc. A Media Server is used to establish and authenticate (where necessary) connections by which media is provided to client devices using the Media Server. Resource Servers 106 are servers that provide the actual media streams to client devices, once the connections by which media is provided to the client devices has been established by a Media Server. Resource Servers 106 may provide any type of media resource, such as audio, video, images, faxes, conferences, etc. A particular Resource Server may provide only one type of media resources or a Resource Server may provide a plurality of media resources. Client devices 108A-N are any type of device that requests access to media and receives/transmits the requested media streams. Such devices may include personal computers, Web-enabled televisions, mobile telephones and PDAs, etc.

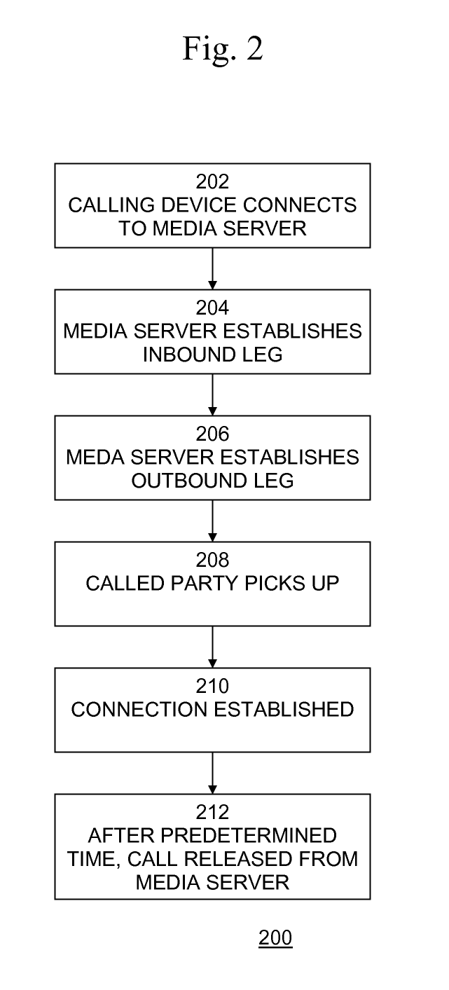

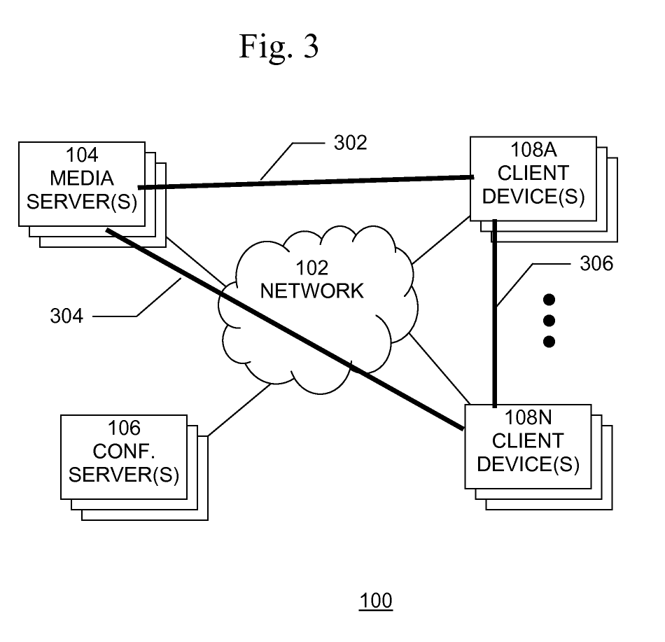

An exemplary flow diagram of a process 200 of media connection of two or more client devices is shown in FIG. 2. It is best viewed in conjunction with FIG. 3, which is an exemplary data flow diagram of media connection of two or more client devices. Process 200 begins with step 202, in which a calling client device 108A connects to a Media Server 104. In step 204, Media Server 104 authenticates (if necessary) calling client device 108A and establishes inbound leg 302 of the media stream. In step 206, Media Server 104 connects to at least one called client device 108N and establishes outbound leg 304 of the media stream. In step 208, the at least one called party using the at least one called client device 108N picks up, that is, accepts connection to the media stream. In step 210, the completed connection between calling client device 108A and the at least one called client device 108N, including inbound leg 302 and outbound leg 304 of the media stream is established. In step 212, Media Server 104 waits a predetermined amount of time, then releases the media stream. In order to do this, Media Server 104 communicates the necessary information to client devices 108A and 108N to cause client devices 108A and 108N to establish media stream 306, which is communicated between client devices 108A and 108N without using Media Server 104.

It is to be noted that all media streams contemplated by the present invention may be unidirectional or bidirectional. References to “inbound” or “outbound” legs do not indicate directionality of the media stream, but merely refer to the direction in which requests for connection flow, relative to a Media Server.

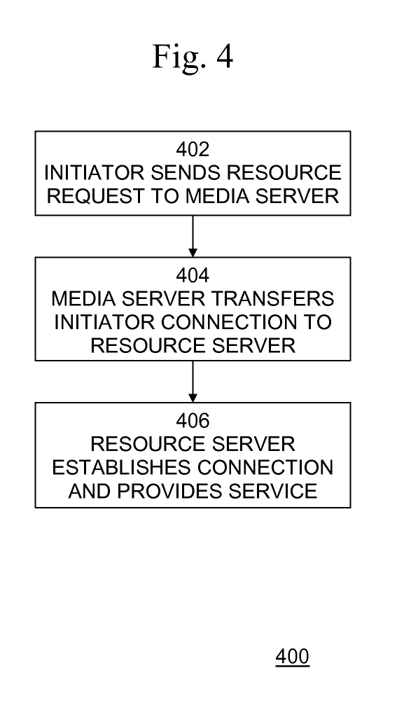

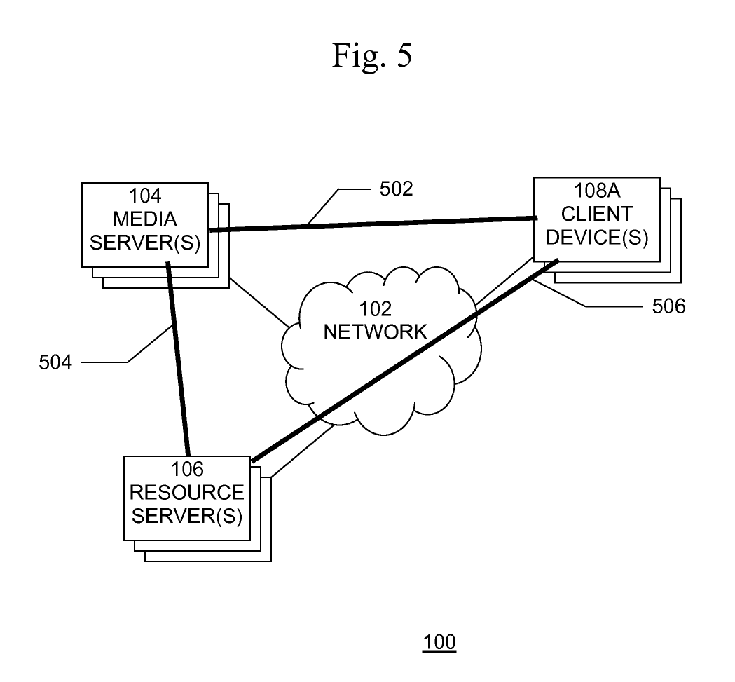

An exemplary flow diagram of a process 400 of media connection of a variety of types of media streams, using a number of different types of Resource Servers, is shown in FIG. 4. It is best viewed in conjunction with FIG. 5, which is an exemplary data flow diagram of media connection of one or more client devices with media stream using one or more Resource Servers. Process 400 begins with step 402, in which initiating client device 108A connects 502 to a Media Server 104 and requests a media resource from Media Server 104. Media Server 104 authenticates (if necessary) initiating client device 108A. In step 404, Media Server 104 selects an appropriate Resource Server 106, based on the request from initiating client device 108A. Media Server 104 transfers 504 the connection to the selected Resource Server 106. In step 406, Resource Server 106 establishes media stream 506 with client device 108A and provides the requested resource.

Resource Servers 106 may provide any type of media resource, such as audio, video, images, faxes, conferences, etc. A Resource Server providing a particular type of media resource may be termed based on the type of resource being provided. For example, a Resource Server may provide conference services, either audio only or audio/video. As additional examples, a Resource Server may provide image or video services, and/or fax transmission/reception services.

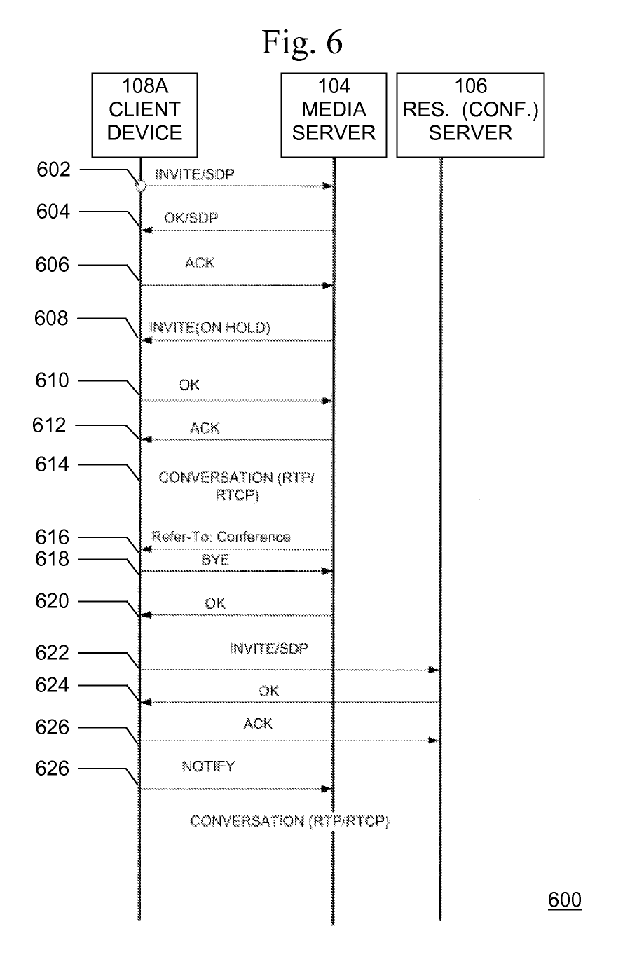

An exemplary flow diagram of a process 600 of conference connection of two or more client devices is shown in FIG. 6. Process 600 begins with step 602, in which a calling client device 108A transmits a SIP INVITE message to Media Server 104. In step 604, Media Server 104 responds by transmitting a SIP OK message to calling client device 108A. In step 606, calling client device 108A acknowledges the response by transmitting a SIP ACK message to Media Server 104. In step 608, Media Server 104 transmits a SIP INVITE message to calling client device 108A indicating that calling client device 108A is on hold. In step 610, calling client device 108A responds by transmitting a SIP OK message to Media Server 104. In step 612, Media Server 104 acknowledges the response by transmitting a SIP ACK message to calling client device 108A. In step 614, calling client device 108A communicates an RTP stream containing the conference audio and/or video data with Media Server 104. In step 616, Media Server 104 identifies the media stream as requiring conference resources and communicates the necessary information for calling client device 108A to communicate directly with Resource (Conference) Server 106. In step 618, calling client device 108A transmits a SIP BYE command to Media Server 104. In step 620, Media Server 104 responds by transmitting a SIP OK message to calling client device 108A. In step 622, calling client device 108A bypasses Media Server 104 and transmits a SIP INVITE message to Conference Server 106. In step 624, Conference Server 106 transmits a SIP OK message to calling client device 108A. In step 626, calling client device 108A acknowledges the OK by transmitting a SIP ACK message to Conference Server 106. In step 626, calling client device 108A notifies Media Server 104 that connection with Conference Server 106 was successfully established.

It is to be noted that the RTP stream may be communicated using any known technique. An example of such a technique is described in U.S. Patent Application Publication No. 2009/0077245.

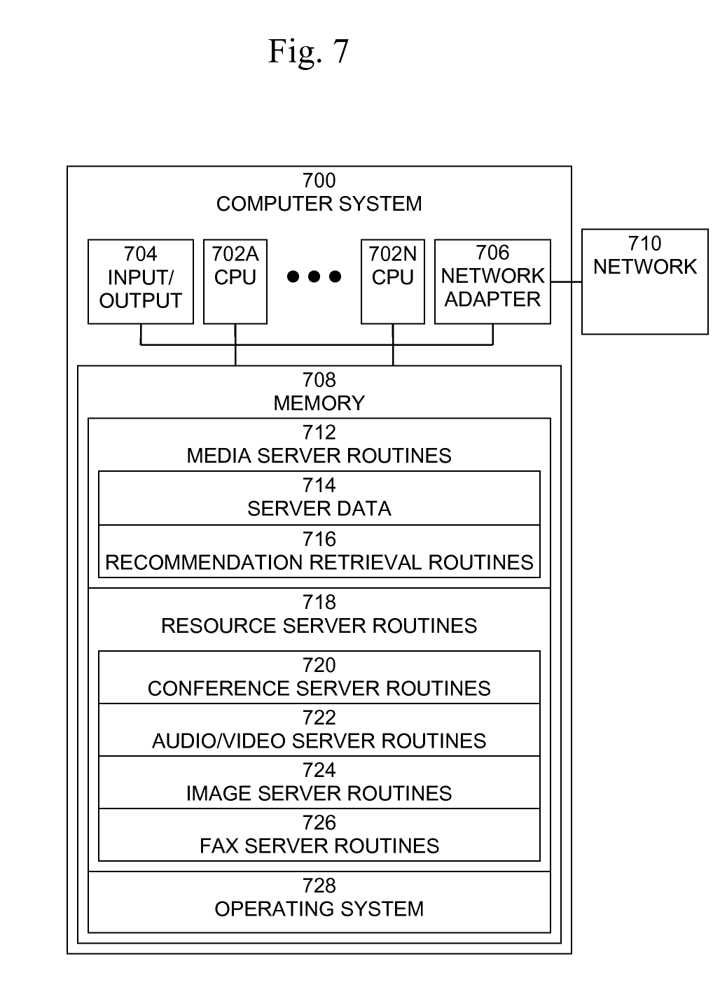

An exemplary block diagram of a computer system 700, such as a Media Server or a Resource Server, is shown in FIG. 7. System 700 is typically a programmed general-purpose computer system, such as a personal computer, workstation, server system, and minicomputer or mainframe computer. System 700 includes one or more processors (CPUs) 702A-702N, input/output circuitry 704, network adapter 706, and memory 708. CPUs 702A-702N execute program instructions in order to carry out the functions of the present invention. Typically, CPUs 702A-702N are one or more microprocessors, such as an INTEL PENTIUM® processor. FIG. 7 illustrates an embodiment in which System 700 is implemented as a single multi-processor computer system, in which multiple processors 702A-702N share system resources, such as memory 708, input/output circuitry 704, and network adapter 706. However, the present invention also contemplates embodiments in which system 700 is implemented as a plurality of networked computer systems, which may be single-processor computer systems, multi-processor computer systems, or a mix thereof.

Input/output circuitry 704 provides the capability to input data to, or output data from, database/system 700. For example, input/output circuitry may include input devices, such as keyboards, mice, touchpads, trackballs, scanners, etc., output devices, such as video adapters, monitors, printers, etc., and input/output devices, such as, modems, etc. Network adapter 706 interfaces device 700 with network 710. Network 710 includes any communications network that is now in service or which may be developed in the future. Such a network may include one or more public or private communications networks, such as the Internet, wired or wireless telephone networks, wired or wireless data networks, local area networks, etc.

Memory 708 stores program instructions that are executed by, and data that are used and processed by, CPU 702 to perform the functions of system 700. Memory 708 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface, or Serial AT Attachment (SATA), or a variation or enhancement thereof.

The contents of memory 708 varies depending upon the function that system 700 is programmed to perform. For example, where system 700 is a Media Server, memory 708 includes Media Server routines 712, such as SIP routines, media stream connection routines, etc. As another example, where system 700 is a Resource Server, memory 708 includes Resource Server routines 718, which may include one or more of Conference Server routines 720, Audio/Video Server routines 722, Image Server routines 724, and/or FAX Server Routines 726. These are merely examples of routines that may be included in a Resource Server, the actual routines included depend upon the functionality to be implemented in the Resource Server. Operating system 728 provides overall system functionality.

As shown in FIG. 7, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable storage media include, floppy disks, hard disk drives, CD-ROMs, DVDROMs, RAM, flash memory, etc.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for providing media services comprising:
receiving a request for media services from an initiating client device at a Media Server;
determining, at the Media Server, a type of media resource needed to service the request and selecting a Resource Server based on the determined type of media resource; and
establishing, by the Media Server, a media service connection between at least the initiating client device and the selected Resource Server to provide the requested media service, wherein the established media service connection does not include the Media Server.

2. The method of claim 1, wherein the type of the requested media service comprises at least one of an audio service, a video service, an audio/video service, an image service, a fax service, and a conference service.

3. The method of claim 1, wherein the selected Resource Server comprises at least one of an audio server, a video server, an audio/video server, an image server, a fax server, and a conference server.

4. The method of claim 1, wherein the Media Server is implemented as a subset or feature of a proxy server, or the Media Server is implemented as a self-contained package.

5. A computer program product for providing media services comprising a computer readable storage medium and computer program instructions, recorded on the computer readable medium and executable by a processor, for performing the steps of:
receiving a request for media services from an initiating client device at a Media Server;
determining, at the Media Server, a type of media resource needed to service the request and selecting a Resource Server based on the determined type of media resource; and
establishing, by the Media Server, a media service connection between at least the initiating client device and the selected Resource Server to provide the requested media service, wherein the established media service connection does not include the Media Server.

6. The computer program product of claim 1, wherein the type of the requested media service comprises at least one of an audio service, a video service, an audio/video service, an image service, a fax service, and a conference service.

7. The computer program product of claim 1, wherein the selected Resource Server comprises at least one of an audio server, a video server, an audio/video server, an image server, a fax server, and a conference server.

8. The computer program product of claim 1, wherein the Media Server is implemented as a subset or feature of a proxy server, or the Media Server is implemented as a self-contained package.

9. A Media Server for providing media services comprising a processor operable to execute computer program instructions, a memory operable to store computer program instructions executable by the processor, and computer program instructions stored in the memory and executable to perform the steps of:
receiving a request for media services from an initiating client device;
determining a type of media resource needed to service the request and selecting a Resource Server based on the determined type of media resource; and
establishing a media service connection between at least the initiating client device and the selected Resource Server to provide the requested media service, wherein the established media service connection does not include the Media Server.

10. The Media Server of claim 1, wherein the type of the requested media service comprises at least one of an audio service, a video service, an audio/video service, an image service, a fax service, and a conference service.

11. The Media Server of claim 1, wherein the selected Resource Server comprises at least one of an audio server, a video server, an audio/video server, an image server, a fax server, and a conference server.

12. The Media Server of claim 1, wherein the Media Server is implemented as a subset or feature of a proxy server, or the Media Server is implemented as a self-contained package.

13. A method for providing conference services comprising:
accepting connection, at a Media Server, from a calling client device;
establishing, at the Media Server, an inbound leg of a media stream with the calling client device;
connecting, from the Media Server, to at least one called client device;
establishing, at the Media Server, an outbound leg of the media stream with the at least one called client device;
determining, at the Media Server, that at least one called client device has accepted connection to the media stream;
completing, at the Media Server, a connection between the calling client device and the at least one called client device, the connection including the inbound leg of the media stream and the outbound leg of the media stream; and
waiting, at the Media Server, a predetermined amount of time, then releasing the media stream by establishing a media stream between the calling client device and the at least one called client device that does not include the Media Server.

14. The method of claim 1, wherein the Media Server is implemented as a subset or feature of a proxy server, or the Media Server is implemented as a self-contained package.

15. The method of claim 1, wherein before establishing the inbound leg of a media stream, the Media Server authenticates the calling client device.

16. A computer program product for providing conference services comprising a computer readable storage medium and computer program instructions, recorded on the computer readable medium and executable by a processor, for performing the steps of:
accepting connection, at a Media Server, from a calling client device;
establishing, at the Media Server, an inbound leg of a media stream with the calling client device;
connecting, from the Media Server, to at least one called client device;
establishing, at the Media Server, an outbound leg of the media stream with the at least one called client device;
determining, at the Media Server, that at least one called client device has accepted connection to the media stream;
completing, at the Media Server, a connection between the calling client device and the at least one called client device, the connection including the inbound leg of the media stream and the outbound leg of the media stream; and
waiting, at the Media Server, a predetermined amount of time, then releasing the media stream by establishing a media stream between the calling client device and the at least one called client device that does not include the Media Server.

17. The computer program product of claim 1, wherein the Media Server is implemented as a subset or feature of a proxy server, or the Media Server is implemented as a self-contained package.

18. The computer program product of claim 1, wherein before establishing the inbound leg of a media stream, the Media Server authenticates the calling client device.

19. A Media Server for providing conference services comprising a processor operable to execute computer program instructions, a memory operable to store computer program instructions executable by the processor, and computer program instructions stored in the memory and executable to perform the steps of:
accepting connection, at a Media Server, from a calling client device;
establishing, at the Media Server, an inbound leg of a media stream with the calling client device;
connecting, from the Media Server, to at least one called client device;
establishing, at the Media Server, an outbound leg of the media stream with the at least one called client device;
determining, at the Media Server, that at least one called client device has accepted connection to the media stream;
completing, at the Media Server, a connection between the calling client device and the at least one called client device, the connection including the inbound leg of the media stream and the outbound leg of the media stream; and
waiting, at the Media Server, a predetermined amount of time, then releasing the media stream by establishing a media stream between the calling client device and the at least one called client device that does not include the Media Server.

20. The Media Server of claim 1, wherein the Media Server is implemented as a subset or feature of a proxy server, or the Media Server is implemented as a self-contained package.

21. The Media Server of claim 1, wherein before establishing the inbound leg of a media stream, the Media Server authenticates the calling client device.
